(19) United States
(12) Patent Application Publication
(10) Pub. No.: US 2015/0242906 A1
(43) Pub. Date: Aug. 27, 2015

(54) GENERATING A SET OF RECOMMENDED NETWORK USER IDENTIFIERS FROM A FIRST SET OF NETWORK USER IDENTIFIERS AND ADVERTISER BID DATA

(71) Applicants: Jia Liu, Sunnyvale, CA (US); Yijian Bai, San Ramon, CA (US); Manojav Patil, Sunnyvale, CA (US); Deepak Ravichandran, Mountain View, CA (US); Sittichai Jiampojamarn, Sunnyvale, CA (US); Shankar Ponnekanti, Mountain View, CA (US)

(72) Inventors: Jia Liu, Sunnyvale, CA (US); Yijian Bai, San Ramon, CA (US); Manojav Patil, Sunnyvale, CA (US); Deepak Ravichandran, Mountain View, CA (US); Sittichai Jiampojamarn, Sunnyvale, CA (US); Shankar Ponnekanti, Mountain View, CA (US)

(73) Assignee: Google Inc.

(21) Appl. No.: 13/462,425

(22) Filed: May 2, 2012

(51) Int. Cl. G06Q 30/02

(52) U.S. Cl. CPC G06Q 30/0275

(57) ABSTRACT

A computerized method, system for, and computer-readable medium operable to take a first set of network user identifiers and generate a set of recommended network user identifiers based on the first set and advertiser bid data. A processing circuit receives the first set and advertiser bid data for the first set and stores the first set and advertiser bid data for the first set in a memory. The advertiser bid data includes a price offered by the advertiser for the advertiser's content to be shown to a network user identifier in the first set. The processing circuit receives advertiser bid data for a second set. The processing circuit generates a user similarity parameter based on the advertiser bid data for the first set and the advertiser bid data for the second set. The processing circuit generates the set of recommended network user identifiers based on the user similarity parameter.

### BACKGROUND

The present disclosure relates generally to similar user identifiers.

Information about online users is often unavailable to interested parties, such as website owners and online advertisers. From an advertiser's perspective, placing an advertisement on a web page may or may not be of interest or useful for the end users viewing the web page. In some systems, the content of a web page may be used to help advertisers select advertisements to be provided with the web page. For example, an advertiser selling golf clubs may advertise on a website devoted to golf, since visitors to the website may share a common interest in golf Such systems may use keywords located in the text of the website to identify topics discussed on the website.

### SUMMARY

One or more embodiments described herein provide a computerized method, system for, and computer-readable medium operable to take a first set of network user identifiers and generate a set of recommended network user identifiers based on the first set of network user identifiers and based on advertiser bid data. An illustrative method includes receiving, at a processing circuit, the first set of network user identifiers and advertiser bid data for the first set of network user identifiers, and storing, in a memory, the first set of network user identifiers and the advertiser bid data for the first set of network user identifiers. Advertiser bid data may include a price offered by an advertiser for the advertiser's advertisement to be shown to a network user identifier in the first set of network user identifiers. The method further includes receiving, at the processing circuit, advertiser bid data for a second set of network user identifiers. The method also includes generating, at the processing circuit, a user similarity parameter based on the advertiser bid data for the first set of network user identifiers and the advertiser bid data for the second set of network user identifiers. The processing circuit uses the user similarity parameter to generate the set of recommended network user identifiers.

### BRIEF DESCRIPTION OF THE DRAWINGS

The details of one or more embodiments are set forth in the accompanying drawings and the description below. Other features, aspects, and advantages of the disclosure will become apparent from the description, the drawings, and the claims, in which:

FIG. 1 is a block diagram of a computer system in accordance with an illustrative embodiment.

FIG. 2 is an illustration of an example web page having an advertisement.

FIG. 3 is an example process for identifying similar network user identifiers.

FIG. 4 is an example process for adjusting a model associated with a first set of network user identifiers to optimize a second set of similar network user identifiers.

FIG. 5 is another example process for adjusting a model associated with a first set of network user identifiers to optimize a second set of similar network user identifiers.

### DETAILED DESCRIPTION OF ILLUSTRATIVE EMBODIMENTS

According to some aspects of the present disclosure, the online behaviors of user identifiers may be used to provide audience-based advertising. As used herein, online behavior refers to how a user identifier interacts with web pages on the Internet (e.g., which web pages are visited, the order in which the web pages are visited, how long a particular web page is viewed, and similar information). In some embodiments, a set of user identifiers associated with an online event (e.g., making an online purchase, being added to an advertiser's list of user identifiers, etc.) may be used as a basis to determine user identifiers having similar online behaviors.

A user may opt in or out of allowing an advertisement server to identify and store information about the user and/or about devices operated by the user. For example, the user may opt in to receiving advertisements from the advertisement server that may be more relevant to the user. In some embodiments, the user may be represented as a randomized user identifier (e.g., a cookie, a device serial number, etc.) that contains no personally-identifiable information about the user. For example, information relating to the user's name, demographics, etc., may not be used by the advertisement server unless the user opts in to providing such information. Thus, the user may have control over how information is collected about him or her and used by an advertisement server.

In content-based advertising systems, advertisements are provided based on the content of a web page. For example, a web page devoted to golf may mention the terms “golf” and other golf-related terms. An advertising system that places advertisements on the web page may use the content of the web page itself and/or terms provided as part of a request for an advertisement (e.g., via an advertisement tag embedded into the code of the web page), to determine a theme for the web page. Based on the determined theme, a manufacturer of golf clubs may opt to place an advertisement on the web page.

Audience-based advertising, in contrast to content-based advertising, involves selecting advertisements based on the user identifier visiting a web page, instead of the content of the web page itself For example, a user identifier may be associated with making an online reservation at a golf resort and navigating to a financial web page to check the stock market. Based on golf being a potential interest category associated with the user identifier, for example, an advertisement from a manufacturer of golf clubs may be provided with the financial web page, even though the financial web page is unrelated to golf One or more embodiments described herein provides a similar users system. A similar users system takes an advertiser's existing marketing list, which is comprised of cookies that identify users who may have high commercial potential, and expands the advertiser's potential reach. As the cookies are stored on a user's computer via the user's internet browser, individual users can be identified by these stored cookies. Users who have high commercial potential may include, for example, users that purchased something on the advertiser's website, viewed a product on a retail website, or placed a product into the shopping cart, but did not complete the purchase. The similar users system then uses algorithms to identify other groups of users who are like the users on the existing marketing list in terms of similar browsing activity, advertisement click activity, and landing page of the advertisements clicked. Existing marketing lists can be quite small. In some embodiments, a similar users system can allow an advertiser to expand the advertiser's target audience by adding similar users to the advertiser's existing marketing list, even if those users have not been to the advertiser's website.

One or more embodiments described herein may provide a more efficient way for an advertising system to interpret an advertiser's goals and provide better results. According to some embodiments, a model is adjusted based on an advertiser's bids to present relevant content to network user identifiers. Specifically, based on the advertiser's bid, the model determines whether the advertiser is branding/coverage-focused or quality/conversion focused. The model is then adjusted accordingly to optimize coverage versus conversion cost for each advertiser with a focus on performances associated with each similar user identifier. In other words, the advertising system will either choose higher coverage with more expensive conversions, or cheaper conversions with reduced coverage. The advertising system's automatic inference of the advertiser's needs eliminates the need to directly communicate with each advertiser to understand the advertiser's goals.

If the advertiser's bid to present relevant content to similar user identifiers is close to or even higher than the bid that the advertiser previously submitted to present relevant content to network user identifiers in the original set (e.g. the set from which the set of similar user identifiers was generated), the advertiser is likely to be branding/coverage-focused. Thus, the threshold of user similarity for generating the set of similar user identifiers from the original set of network user identifiers is reduced to expand the quantity of similar user identifiers in the set (i.e., a lower threshold corresponds to more user identifiers being selected for the set of similar user identifiers, in some embodiments). On the other hand, if an advertiser's bid to present relevant content to similar user identifiers is much lower than the bid for the to present relevant content to network user identifiers in the original set, the advertiser may be aiming for cheaper conversions. Thus, the threshold of user similarity is raised to reduce coverage and get better quality user identifiers in the set of similar user identifiers.

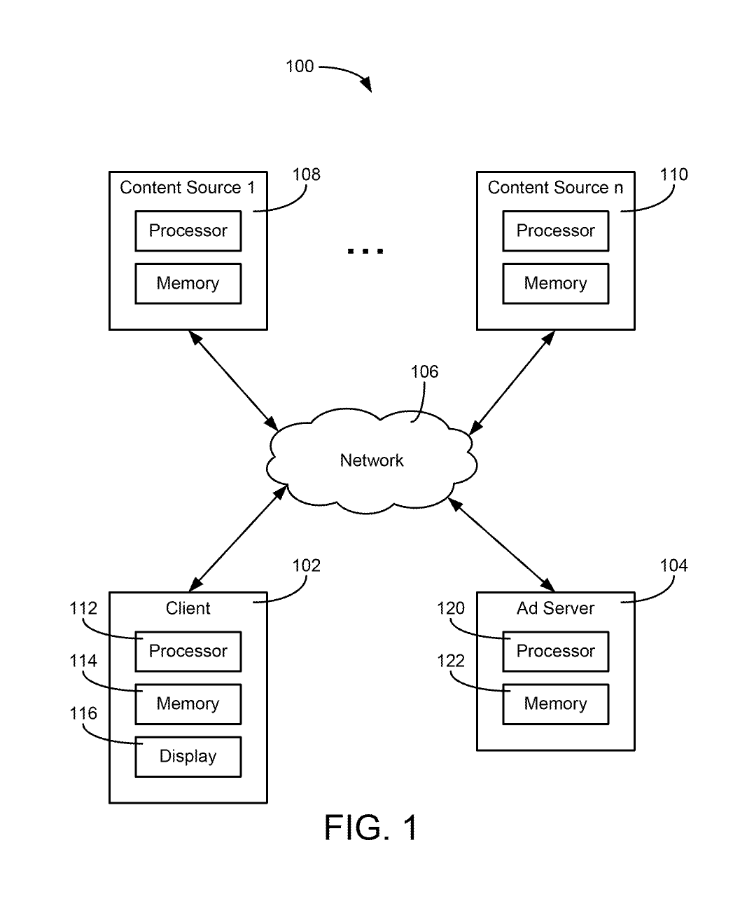

Referring to FIG. 1, a block diagram of a computer system 100 in accordance with a described embodiment is shown. System 100 includes a client 102 which communicates with other computing devices via a network 106. For example, client 102 may communicate with one or more content sources ranging from a first content source 108 up to an nth content source 110. Content sources 108, 110 may provide web pages and/or media content (e.g., audio, video, and other forms of digital content) to client 102. System 100 may also include an advertisement server 104, which provides advertisement data to other computing devices over network 106.

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

Network 106 may be any form of computer network that relays information between client 102, advertisement server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, application-specific integrated circuit (ASIC), field programmable gate array (FPGA), read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various embodiments. For example, client 102 may include an electronic display 116, which visually displays web pages using web page data received from content sources 108, 110 and/or from advertisement server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, web page data, a movie, a sound file, pictures, and other forms of data. Similarly, advertisement server 104 may include a processing circuit including a processor 120 and a memory 122.

In some embodiments, advertisement server 104 may include several computing devices (e.g., a data center, a network of servers, etc.). In such a case, the various devices of advertisement server 104 may be in electronic communication, thereby also forming a processing circuit (e.g., processor 120 includes the collective processors of the devices and memory 122 includes the collective memories of the devices).

Advertisement server 104 may provide digital advertisements to client 102 via network 106. For example, content source 108 may provide a web page to client 102, in response to receiving a request for a web page from client 102. In some embodiments, an advertisement from advertisement server 104 may be provided to client 102 indirectly. For example, content source 108 may receive advertisement data from advertisement server 104 and use the advertisement as part of the web page data provided to client 102. In other embodiments, an advertisement from advertisement server 104 may be provided to client 102 directly. For example, content source 108 may provide web page data to client 102 that includes a command to retrieve an advertisement from advertisement server 104. On receipt of the web page data, client 102 may retrieve an advertisement from advertisement server 104 based on the command and display the advertisement when the web page is rendered on display 116.

According to some embodiments, advertisement server 104 may be configured to determine whether the online behavior of a user identifier from client 102 is similar to that of other user identifiers. In some cases, advertisement server 104 may determine the similarity between the online behavior associated with a user identifier and that of other user identifiers associated with a desired action, such as purchasing a certain good or navigating to a certain web page. For example, a number of user identifiers may be associated with visiting web pages from content sources 108, 110 devoted to tourist attractions in Seattle and going on to purchase airline tickets to Seattle. In such a case, advertisement server 104 may determine that a user identifier associated with client 102 is similar to those user identifiers associated with a purchase of airline tickets to Seattle based on client 102 navigating to web pages provided by content sources 108, 110.

In some embodiments, advertisement server 104 may receive browsing history data to determine the online behaviors of user identifiers around a certain event. In some embodiments, advertisement server 104 may use cookies and/or pixel tags to determine an online behavior of a user identifier. For example, a cookie associated with advertisement server 104 may be placed on client 102 and used as a user identifier. Whenever client 102 navigates to a web page that includes an advertisement from advertisement server 104, the cookie may be used to identify client 102 as having visited the web page. Other mechanisms to determine a user's browsing history may be used, in various embodiments. For example, client 102 may have a unique device ID which may be used to identify client 102 as it navigates between different websites. In some cases, client 102 may navigate to websites that are outside of the advertising network of advertisement server 104 (e.g., the website does not include an advertisement from advertisement server 104). In some embodiments, advertisement server 104 may receive publisher-provided data (e.g., user identifiers) from websites that are outside of the advertising network.

A user of client 102 may opt in or out of allowing advertisement server 104 to identify and store data relating to client 102. For example, the user may opt in to receiving advertisements from advertisement server 104 that may be more relevant to them. In some embodiments, the client identifier used by advertisement server 104 may be randomized and contain no personally-identifiable information about the user. For example, information relating to the user's name, demographics, etc., may not be used by advertisement server 104 unless the user opts in to providing such information. Thus, the user of client 102 may have control over how information is collected about them and used by advertisement server 104, in various embodiments.

According to various embodiments, advertising server 104 may generate a behavioral model based on the online behaviors of user identifiers associated with an online event, such as visiting a certain web page, purchasing a particular good or service, being added to a list of users by an advertiser, or the like. In some embodiments, advertisement server 104 may receive a list of user identifiers from an advertiser (e.g., a set of cookies or other device identifiers). For example, an online retailer may provide a list of user identifiers associated with purchases of a certain good or service to advertisement server 104. Advertisement server 104 may use the provided list to determine a set of similar user identifiers by comparing the online behaviors of the user identifiers on the list to that of other user identifiers. In some cases, advertisement server 104 may provide an indication of the set of identified user identifiers back to the advertiser.

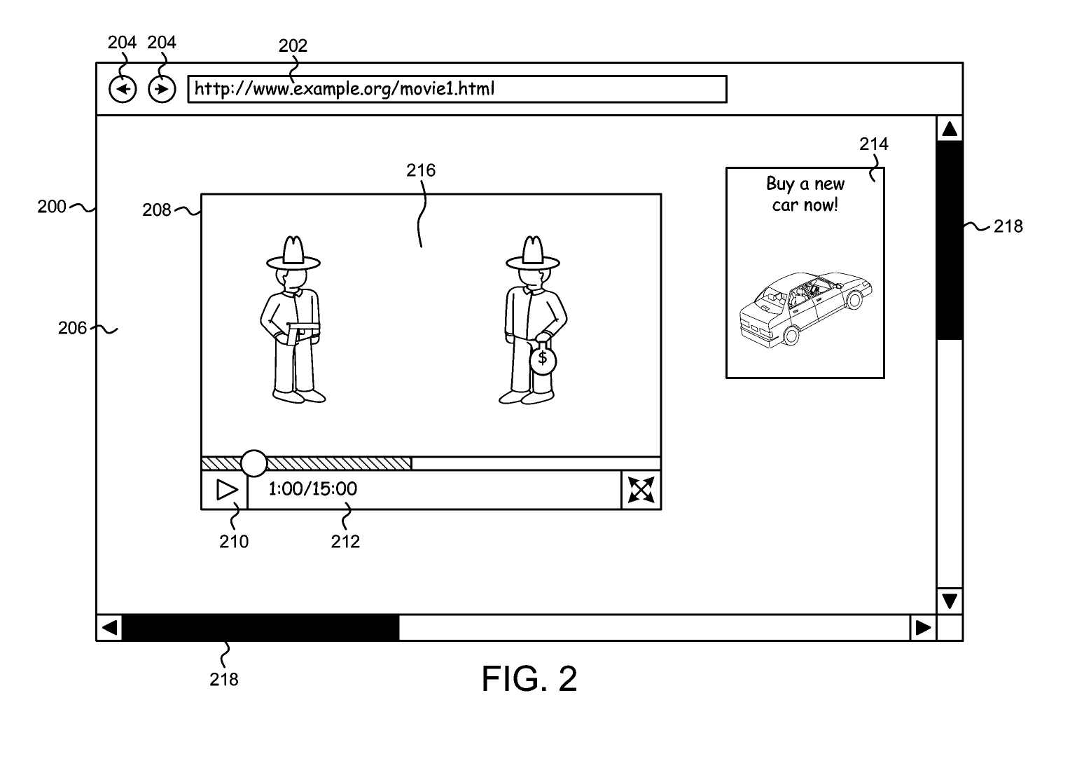

Referring now to FIG. 2, an example display 200 is shown. Display 200 is in electronic communication with one or more processors that cause visual indicia to be provided on display 200. Display 200 may be located inside or outside of the housing of the one or more processors. For example, display 200 may be external to a desktop computer (e.g., display 200 may be a monitor), may be a television set, or any other stand-alone form of electronic display. In another example, display 200 may be internal to a laptop computer, mobile device, or other computing device with an integrated display.

As shown in FIG. 2, the one or more processors in communication with display 200 may execute a web browser application (e.g., display 200 is part of a client device). The web browser application operates by receiving input of a uniform resource locator (URL) into a field 202, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide web page data and/or other data to the client device, which causes visual indicia to be displayed by display 200.

The web browser providing data to display 200 may include a number of navigational controls associated with web page 206. For example, the web browser may include the ability to go back or forward to other web pages using inputs 204 (e.g., a back button, a forward button, etc.). The web browser may also include one or more scroll bars 218, which can be used to display parts of web page 206 that are currently off-screen. For example, web page 206 may be formatted to be larger than the screen of display 200. In such a case, one or more scroll bars 218 may be used to change the vertical and/or horizontal position of web page 206 on display 200.

In one example, additional data associated with web page 206 may be configured to perform any number of functions associated with movie 216. For example, the additional data may include a media player 208, which is used to play movie 216. Media player 208 may be called in any number of different ways. In some embodiments, media player 208 may be an application installed on the client device and launched when web page 206 is rendered on display 200. In another embodiment, media player 208 may be part of a plug-in for the web browser. In another embodiment, media player 208 may be part of the web page data downloaded by the client device. For example, media player 208 may be a script or other form of instruction that causes movie 216 to play on display 200. Media player 208 may also include a number of controls, such as a button 210 that allows movie 216 to be played or paused. Media player 208 may include a timer 212 that provides an indication of the current time and total running time of movie 216.

The various functions associated with advertisement 214 may be implemented by including one or more advertisement tags within the web page code located in “movie1.html” and/or other files. For example, “movie1.html” may include an advertisement tag that specifies that an advertisement slot is to be located at the position of advertisement 214. Another advertisement tag may request an advertisement from a remote location, for example, from an advertisement server, as web page 206 is loaded. Such a request may include client identification data (e.g., a cookie, device ID, etc.) used by the advertisement server as a user identifier. In this way, the advertisement server is able to determine browsing history associated with a user identifier as it is used to navigate between various web pages that participate in the advertising network (e.g., web pages that include advertisements from the advertisement server).

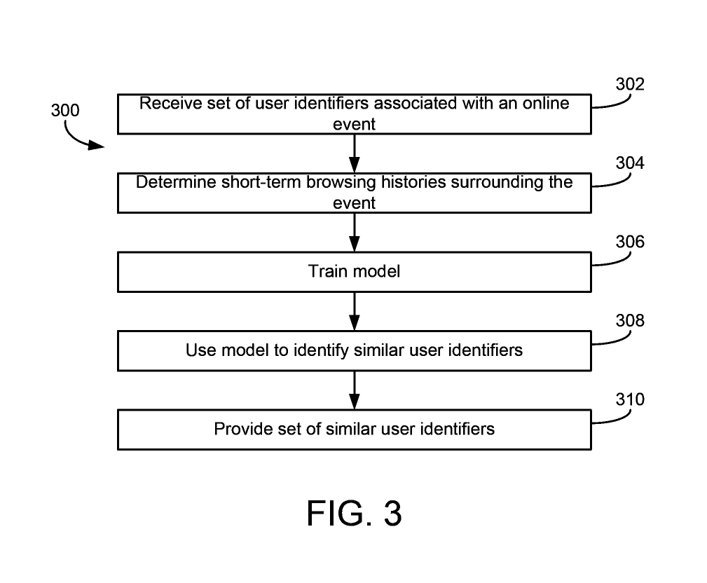

Referring now to FIG. 3, an example process 300 for determining similar online user identifiers. In some embodiments, advertisers may compete in an advertising auction for the ability to place an advertisement on a given web page. An advertiser having access to a set of user identifiers that are similar to other user identifiers associated with making a purchase, for example, may adjust their bid accordingly if one of the similar user identifiers requests a web page having an embedded advertisement.

Process 300 includes receiving data indicative of a set of user identifiers associated with an online event (block 302). In general, an online event may correspond to any action performed by an online user. For example, an online event may correspond to visiting a web page, clicking on a particular link (e.g., a hyperlink, an advertisement link, etc.), navigating between a set of web pages, ending a browsing session, spending a certain amount of time on a given web page, purchasing a good or service, or any other action that may be performed by an online user. In some embodiments, the set of users may be represented using device identifiers (e.g., cookies, device IDs, etc.) for the electronic devices operated by the users. In some embodiments, the set of user identifiers may also include information about when the event occurred with respect to a user in the set. For example, the received set may include information about when a particular user identifier visited a web page, made a purchase, or performed any other online action.

In one example, an online retailer may wish to place advertisements via an advertising network. To provide relevant advertisements, the retailer may generate a list of user identifiers associated with visits to the retailer's website and/or purchases made via the website. The list of user identifiers may be a list of cookies, device IDs, or other information that can be used by the advertising network to determine online behaviors associated with the user identifiers on the list. For example, a mobile telephone having a unique device ID may be used to access the retailer's website. If the user has opted in to allowing information about the user to be collected, the retailer may record the device ID as a user identifier and provide it to the advertising network. The advertising network may then use the user identifier to identify similar user identifiers.

Process 300 includes determining short-term browsing histories surrounding the event (block 304). In some embodiments, the system that receives the set of user identifiers may retrieve information regarding the browsing histories associated with the user identifiers in the set. For example, a server of an advertising network may store browsing history information for user identifiers that visited websites participating in the advertising network (e.g., websites that display advertisements provided by the advertising network). Such information may be collected, for example, by receiving identification information (e.g., a cookie, device ID, etc.) each time a user identifier is used to access a web page displaying an advertisement from the advertising network. Such information may be used to reconstruct, or partially reconstruct, a user's browsing history, provided that the user has opted in to allowing such information to be used. In other embodiments, the browsing history may be predetermined by another device outside of the advertising network (e.g., the browsing history data may be publisher-provided).

The short-term browsing history for a user identifier refers to data about which web pages were visited within a particular period of the online event. In various embodiments, the short-term browsing history for a user identifier surrounding an event may include data about the web pages visited by the user identifier less than one, two, five, twelve, or twenty four hours prior to the event. In some embodiments, the short-term browsing history for a user identifier may include data about the web pages visited by the user identifier less than one, two, five, twelve, or twenty four hours after the occurrence of the event. In some embodiments, long-term browsing histories may be used (e.g., browsing history data from a period longer than the particular period associated with the short-term browsing history). However, in contrast to long-term browsing history, short-term browsing history may provide more insight into a user identifier's interests surrounding the event. For example, a user may have a long-term interest in professional football. However, the user may have a short-term interest in purchasing flowers for his wife's birthday. Analyzing the user's short-term browsing history surrounding his online purchase of flowers may exclude the topic of football from being associated with the purchase of flowers. According to various embodiments, the short-term browsing histories may be determined for the entire set of user identifiers or for a subset of the user identifiers (e.g., a random sampling of the user identifiers, a subset selected up to a predetermined amount of user identifiers, etc.).

Process 300 includes training a model (block 306), such as a behavioral model. In some embodiments, the browsing history data associated with the user identifiers in the received set may be used to train a behavioral model. In general, the behavioral model may determine or represent commonalities among the online behaviors associated with the user identifiers. For example, a large number of user identifiers that purchase organic peanut butter from a retailer may have recently visited a web page devoted to a recipe for an all-organic peanut butter and banana sandwich. Such a characteristic may be used to identify other user identifiers that are also likely to become associated with purchasing organic peanut butter from the retailer.

Process 300 includes using the model to identify similar user identifiers to those in the received set (block 308). In general, the set of similar user identifiers may include device identifiers (e.g., cookies, unique device IDs, etc.) or other information that may be used to determine that a user identifier in the set of similar user identifiers is being used to request a web page. For example, the set of similar user identifiers may be provided to an advertiser and used by the advertiser to select relevant advertisements. In some implementations, the set of similar user identifiers may be provided to an advertising server that conducts an advertising auction (block 310). An advertiser may utilize the set of similar user identifiers to adjust auction bids to provide an advertisement to those user identifiers. For example, a user identifier that visits a web page devoted to plumbing repairs may have a browsing history similar to that of user identifiers associated with purchasing copper tubing. When the user identifier visits a web page, even a web page unrelated to plumbing, advertisers may participate in an auction to place an advertisement on the web page. In such a case, an advertiser may place a higher bid in the auction to provide an advertisement for copper tubing to the user identifier.

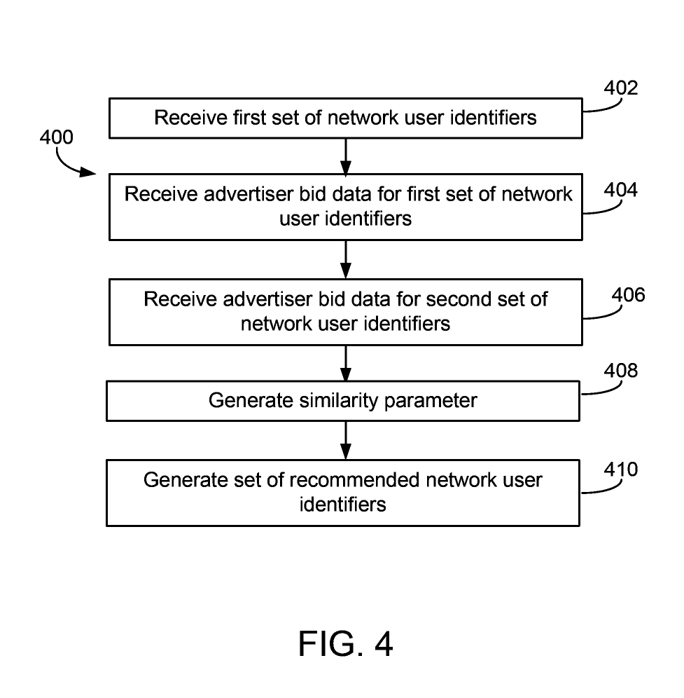

In some embodiments, as illustrated in FIG. 4, the processing circuit performs process 400 to adjust a similar users model based on advertiser bids. Process 400 includes receiving a first set of network user identifiers and storing the first set of network user identifiers in a memory (step 402). Process 400 also includes receiving advertiser bid data for the first set of network user identifiers (step 404). The advertiser bid data includes a price offered by an advertiser for the advertising system to display the advertiser's content to a network user identifier in the first set of network user identifiers. An advertising server may be configured to receive a request to serve an advertisement to a web page, identify relevant content that matches any criteria received along with the request and select one or more relevant content based on the bid, a quality score of each relevant content, and/or other factors. Process 400 further includes receiving advertiser bid data for a second set of network user identifiers (e.g., the set of similar user identifiers) (step 406). The second set of network user identifiers includes network user identifiers that share similar interests with the user identifiers in the first set of network user identifiers. The advertiser bid data for the first and second sets can be stored in the memory.

Process 400 includes generating a user similarity parameter based on the advertiser bid data for the first set of network user identifiers and the advertiser bid data for the second set of network user identifiers (step 408). The user similarity parameter may be a value, variable, or function to be used by a similar user identifiers algorithm as a threshold when determining how similar network user identifiers must be to the first set of network user identifiers in order to be included in the set of similar user identifiers. Based on the advertiser's bid data for the first and second sets of network user identifiers, the processing circuit can determine whether the advertiser is generally more branding/coverage-focused or generally more quality/conversion focused.

If an advertiser's bid to present relevant content to the second set of network user identifiers is close to or even higher than the bid the advertiser previously submitted to present relevant content to the first set of network user identifiers (from which the second set of network user identifiers was generated), the advertiser is likely to be branding/coverage-focused. Branding/coverage-focused means that the advertiser is focused on branding efforts and may use the second set of network user identifiers to get more coverage for the advertiser's content. If the advertiser is branding/coverage-focused, the user similarity parameter is decreased in order to increase the number of network user identifiers in the second set of network user identifiers. In other words, the quantity of similar user identifiers that will be shown relevant content will be expanded.

If an advertiser's bid to present relevant content to the second set of network user identifiers is lower than the bid to present relevant content to the first set of network user identifiers, the advertiser may be performance-focused. Performance-focused means that the advertiser is focused on obtaining more conversions for a cheaper price from the second set of network user identifiers. If the advertiser is performance-focused, the user similarity parameter is increased in order to reduce the number of network user identifiers in the second set of network user identifiers. In other words, the quality of similar user identifiers that will be shown relevant content will be increased because the network user identifiers comprising the second set of network user identifiers will possess more similar characteristics. Thus, the second set of network user identifiers will return cheaper conversions.

In general, a conversion refers to the user, anonymously associated with a network user identifier, performing a certain action. Typically, the action associated with a conversion is the purchase of a good or service. For example, a selected content that led to a conversion may be a content that diverted a user to a website at which the user made a purchase. Other examples of conversions include a user creating a user profile on a website, subscribing to receive marketing offers (e.g., by providing a postal or email address, by providing a telephone number, etc.), or downloading software from a website. A cost-per-conversion can be calculated according to Equation 1 below:

Cost-per-conversion=Cost-per-click*Conversion Rate (Eq. 1).

The conversion rate can be calculated according to Equation 2 below:

$$Conversion Rate = \frac{Number of Clicks}{Number of conversions} . \qquad ( Eq . 2 )$$

By lowering the advertiser bid, the advertiser lowers the cost-per-click, and thus, reduces the cost-per-conversion. A conversion may be considered a cheaper conversion if it costs the advertiser less money to get a conversion. This can be accomplished if the quality of network user identifiers in the second set of network user identifiers is increased.

In some embodiments, the user similarity parameter may be a default similarity parameter used for a particular advertiser or a particular categorical interest. In other embodiments, the default similarity parameter can be adjusted to obtain the user similarity parameter according to Equation 3 below:

$$User Similarity Parameter = \frac{Default Similarity Parameter * k * Bid for Second List}{Bid for First List} , \qquad ( Eq . 3 )$$

where k is a tuning constant factor between 0 and 1. The tuning constant factor k is used to control the degree in which advertiser bid data is used to change the default similarity parameter. The tuning constant factor is a system constant whose value does not change regardless of the advertiser's identity. For example, if the value of “k” is increased from 0.4 to 0.5, the similar users system uses 0.5 as the value of “k” when calculating the user similarity parameter for every set associated with every advertiser in the advertising system. The user similarity parameter may be adjusted at any frequency, for example, daily, weekly, monthly, etc.

In one example, pseudocode for the calculation of the adjusted similarity parameter is as follows:

similarity-parameter-adjustment-ratio(Ad2)<−k*bid(Ad1)/bid(Ad2)

similarity-parameter(Ad2)<−default-similarity-parameter*similarity-parameter-adjustment-ratio(Ad2)

In this example, Ad1 is the first set of network user identifiers and Ad2 is the corresponding second set of network user identifiers (e.g. the set of similar user identifiers). Similar to Equation 3, k is a tuning constant factor between 0 and 1 that is used to control the degree in which advertiser bid data is used to change the default similarity parameter. The default-similarity-parameter, as its name suggests, is a default value applied to all advertisement campaigns processed by the advertising system. The similarity-parameter(Ad2) is a numerical value that determines whether a network user identifier is similar enough to be included in the advertisement campaign processed by the advertising system. As the numerical value increases, the level of similarity required for a candidate network user identifier to be considered a similar user identifier also increases. This is why higher similarity parameters yield higher quality lists of similar user identifiers.

The user similarity parameter is used to train a behavioral model associated with the first set of network user identifiers, in a manner similar to that discussed in block 306 of process 300. Using the trained behavioral model, process 400 includes generating a set of recommended network user identifiers comprised of network user identifiers sharing similar characteristics with the network user identifiers in the first set of network user identifiers (step 410). The set of recommended network user identifiers may be stored in the memory. The processing circuit may generate display data configured to display the set of recommended network user identifiers and/or the user similarity parameter on a user interface.

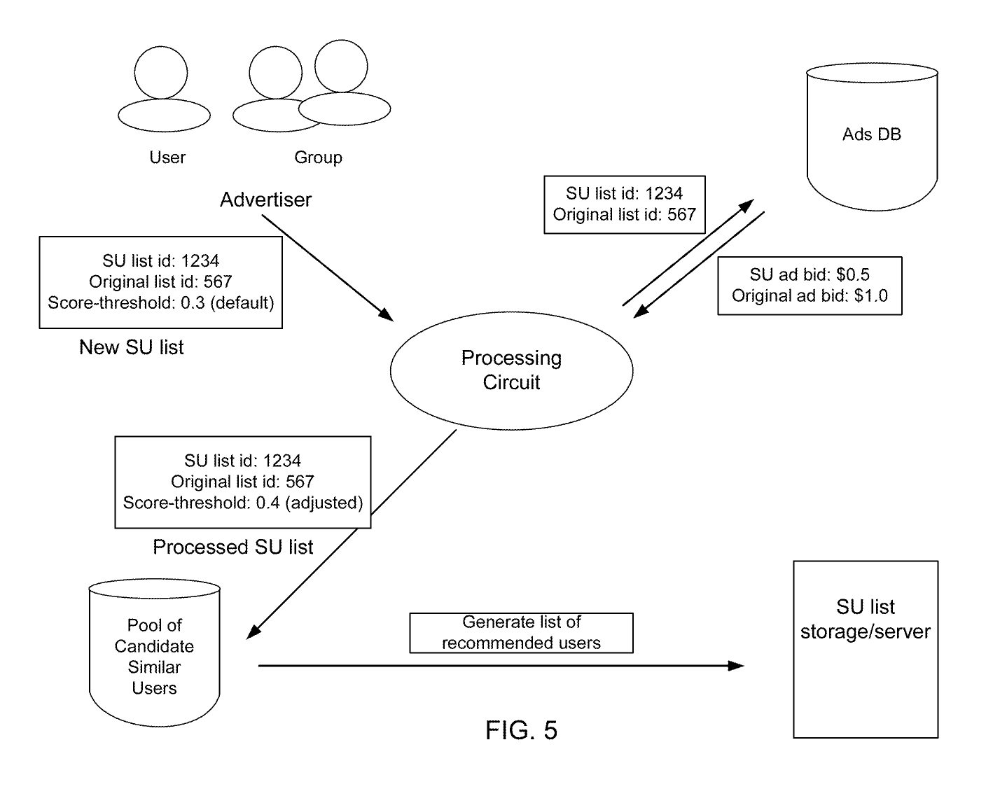

FIG. 5 is an example of the process described in FIG. 4. In FIG. 5, an advertiser (e.g. a single user or a group of users) submits a first set of network user identifiers having an original list id: 567 with a score-threshold (hereafter “default similarity parameter”) of 0.3 in order to obtain a second set of network user identifiers having a similar users (referred to as “SU” in FIG. 5) list id: 1234. The default similarity parameter is a default value applied to all advertisement campaigns processed by the advertising system. The default similarity parameter may be adjusted by the advertising system depending on the needs of each advertiser. Given the list id for the first and second sets of network user identifiers, an advertisement database (referred to as “Ads DB” in FIG. 5) returns the advertiser bid data to the processing circuit. In this example, the bid for the first set of network user identifiers is $1.00, while the bid for the second set of network user identifiers is $0.50. Since the advertiser's bid to present relevant content to the second set of network user identifiers is lower than the bid to present relevant content to the first set of network user identifiers, the advertiser may be performance-focused. Based on the advertiser bid information, the processing circuit automatically adjusts the similarity parameter to optimize the second set of network user identifiers, resulting in the return of cheaper conversions. Because the advertiser is performance-focused, the user similarity parameter is increased from 0.3 to 0.4 in order to reduce the number of network user identifiers in the second set of network user identifiers. In other words, the quality of similar user identifiers that will be shown relevant content will be increased because the network user identifiers comprising the second set of network user identifiers will possess more similar characteristics. The user similarity parameter is used to train a behavioral model associated with the first set of network user identifiers and generate a set of recommended network user identifiers. The trained behavioral model and the set of recommended network user identifiers may be stored in memory on a server.

Although it is possible to directly communicate with each advertiser to determine whether the advertiser is branding/coverage-focused or performance-focused, doing so would involve prohibitive costs and investments of time. By being able to automatically deduce the advertiser's goals based on the advertiser bid data, the processing circuit can optimize the second set of network user identifiers for each advertiser.

Embodiments of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

The term “client” or “server” includes all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display), OLED (organic light emitting diode),TFT (thin-film transistor), plasma, other flexible configuration, or any other monitor for displaying information to the user and a keyboard, a pointing device, e.g., a mouse trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface (GUI) or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific embodiment details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product embodied on a tangible medium or packaged into multiple software products embodied on tangible media.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

While the above description contains many specifics, these specifics should not be construed as limitations on the scope of the invention, but merely as exemplifications of the disclosed embodiments. Those skilled in the art will envision many other possible variations that are within the scope of the invention as defined by the claims appended hereto.

1. (canceled)

2. The method of claim 5, wherein the user similarity parameter is further based on a default similarity parameter.

3. The method of claim 5, wherein the user similarity parameter is further based on a tuning constant, k.

4. The method of claim 3, wherein the user similarity parameter is calculated according to the following equation:
$$User Similarity Parameter = \frac{Default Similarity Parameter * k * Bid for Second List}{Bid for First List}$$

5. A computerized method of taking a first set of network user identifiers and generating a second set of network user identifiers based on the first set of network user identifiers and based on advertiser bid data, the method comprising:
receiving, at a processing circuit, the first set of network user identifiers;
storing, in a memory, the first set of network user identifiers;
receiving, at the processing circuit, first advertiser bid data for the first set of network user identifiers, wherein the first advertiser bid data comprises a first advertiser bid price offered by an advertiser to show relevant content to a network user identifier in the first set of network user identifiers;
storing, in the memory, the first advertiser bid data for the first set of network user identifiers;
receiving, at the processing circuit, second advertiser bid data for a second set of network user identifiers, wherein the second advertiser bid data comprises a second advertiser bid price offered by the advertiser to show relevant content to a network user identifier in the second set of network user identifiers;
generating, at the processing circuit, a user similarity parameter, the user similarity parameter is used to determine how similar candidate network user identifiers of the second set of network user identifiers must be to the first set of network user identifiers in order to be placed in the second set of network user identifiers, wherein the user similarity parameter is based at least on the first advertiser bid data for the first set of network user identifiers and the second advertiser bid data for the second set of network user identifiers; and
generating, by the processing circuit, using the candidate network user identifiers, the second set of network user identifiers based on the user similarity parameter, wherein the second set of network user identifiers comprises more network user identifiers in a first case in which the second advertiser bid price is higher than the first advertiser bid price than in a second case in which the second advertiser bid price is lower than the first advertiser bid price.

6. The method of claim 5, further comprising generating display data configured to display the second set of network user identifiers and an indication of the user similarity parameter on a user interface.

7. (canceled)

8. The system of claim 11, wherein the user similarity parameter is further based on a default similarity parameter.

9. The system of claim 11, wherein the user similarity parameter is further based on a tuning constant, k.

10. The system of claim 9, wherein the user similarity parameter is calculated according to the following equation:
$$User Similarity Parameter = \frac{Default Similarity Parameter * k * Bid for Second List}{Bid for First List}$$

11. A system for taking a first set of network user identifiers and generating a second set of network user identifiers based on the first set of network user identifiers and based on advertiser bid data comprising a processing circuit operable to:
receive, at the processing circuit, the first set of network user identifiers;
store, in a memory, the first set of network user identifiers;
receive, at the processing circuit, first advertiser bid data for the first set of network user identifiers, wherein the first advertiser bid data comprises a first advertiser bid price offered by an advertiser to show relevant content to a network user identifier in the first set of network user identifiers;
store, in the memory, the first advertiser bid data for the first set of network user identifiers;
receive, at the processing circuit, second advertiser bid data for a second set of network user identifiers, wherein the second advertiser bid data comprises a second advertiser bid price offered by the advertiser to show relevant content to a network user identifier in the second set of network user identifiers;
generate, at the processing circuit, a user similarity parameter, the user similarity parameter is used to determine how similar candidate network user identifiers must be to the first set of network user identifiers in order to be placed in the second set of network user identifiers, wherein the user similarity parameter is based at least on the first advertiser bid data for the first set of network user identifiers and the second advertiser bid data for the second set of network user identifiers; and
generate, by the processing circuit, using the candidate network user identifiers, the second set of network user identifiers based on the user similarity parameter, wherein the second set of network user identifiers comprises more network user identifiers in a first case in which the second advertiser bid price is higher than the first advertiser bid price than in a second case in which the second advertiser bid price is lower than the first advertiser bid price.

12. The system of claim 11, wherein the processing circuit is further operable to generate display data configured to display the second set of network user identifiers and an indication of the user similarity parameter on a user interface.

13. (canceled)

14. The computer-readable storage medium of claim 17, wherein the user similarity parameter is further based on a default similarity parameter.

15. The computer-readable storage medium of claim 17, wherein the user similarity parameter is further based on a tuning constant, k.

16. The computer-readable storage medium of claim 15, wherein the user similarity parameter is calculated according to the following equation:
$$User Similarity Parameter = \frac{Default Similarity Parameter * k * Bid for Second List}{Bid for First List}$$

17. A non-transitory computer-readable storage medium having instructions thereon that cause one or more processors to perform operations, the operations comprising:
receiving, at a processing circuit, a first set of network user identifiers;
storing, in a memory, the first set of network user identifiers;
receiving, at the processing circuit, first advertiser bid data for the first set of network user identifiers, wherein the first advertiser bid data comprises a first advertiser bid price offered by an advertiser to show relevant content to a network user identifier in the first set of network user identifiers;
storing, in the memory, the first advertiser bid data for the first set of network user identifiers;
receiving, at the processing circuit, second advertiser bid data for a second set of network user identifiers, wherein the second advertiser bid data comprises a second advertiser bid price offered by the advertiser to show relevant content to a network user identifier in the second set of network user identifiers;
generating, at the processing circuit, a user similarity parameter, the user similarity parameter is used to determine how similar candidate network user identifiers must be to the first set of network user identifiers in order to be placed in the second set of network user identifiers, wherein the user similarity parameter is based at least on the first advertiser bid data for the first set of network user identifiers and the second advertiser bid data for the second set of network user identifiers; and
generating, by the processing circuit, using the candidate network user identifiers, the second set of network user identifiers based on the user similarity parameter, wherein the second set of network user identifiers comprises more network user identifiers in a first case in which the second advertiser bid price is higher than the first advertiser bid price than in a second case in which the second advertiser bid price is lower than the first advertiser bid price.

18. The computer-readable storage medium of claim 17, wherein the operations further comprise generating display data configured to display the second set of network user identifiers and an indication of the user similarity parameter on a user interface.
